(19) United States
(12) Patent Application Publication
(10) Pub. No.: US 2008/0077972 A1
(43) Pub. Date: Mar. 27, 2008

(54) Configuration-less authentication and redundancy

(75) Inventors: Randy Chou, San Jose, CA (US); Brijesh Nambiar, Sunnyvale, CA (US)

Correspondence Address: BLAKELY SOKOLOFF TAYLOR & ZAFMAN, 1279 OAKMEAD PARKWAY, SUNNYVALE, CA, 94085-4040, US

(73) Assignee: Aruba Wireless Networks

(21) Appl. No.: 11/525,277

(22) Filed: Sep. 21, 2006

(51) Int. Cl. H04L 9/32

(52) U.S. Cl. 726/2

(57) ABSTRACT

In some embodiments, an apparatus includes a switch to interface between clients, the switch including an authentication server to perform client authentication for at least one of the clients. Other embodiments are described.

### FIELD

Embodiments of the invention relate to the field of communication security, and in particular, to a system, apparatus, and method for providing local client authentication, such as wireless authentication.

### GENERAL BACKGROUND

Various communication networks have been created to allow access to various network resources. To improve efficiency and to support mobility, many wireless access enhancements have been added to local, personal, and wide area networks. Based on these enhancements, Wireless Local Area Networks (WLANs), Personal Area Networks (PANs) and Wide Area Networks (WANs) have been and continue to be utilized by more and more users.

With WLANs for example, a networking switch may be deployed as a central device between clients and an authentication server including, for example, a RADIUS (Remote Authentication Dial In User Service) server. Normally, the RADIUS server operates as a backend server, performing both client authentication (such as wireless authentication) and user authentication. The RADIUS server performs operations in accordance with a specific (RADIUS) protocol, which is an authentication, authorization, and accounting protocol for applications such as network access or internal protocol (IP) mobility.

IEEE 802.1X is an IEEE standard for protocols for port-based network access control. An 802.1X protocol provides authentication to devices attached to a local area network (LAN) port. It enables connection for authenticated devices and prevents access if the authentication fails. IEEE 802.1X is used to carry an Extensible Authentication Protocol (EAP). The following are some examples of the many types of EAP.

Protected EAP (PEAP) uses Transport Layer Security (TLS) to create an encrypted channel between an authenticated PEAP client and a PEAP authenticator, such as an Internet Authentication Service (IAS) or RADIUS server. Secure Socket Layer (SSL) and Transport Layer Security (TLS), the successor to SSL, are cryptographic protocols that may be used by networking switches to secure data communications over a wireless network. While there are slight differences between SSL and TLS, the overall functionality of these protocols is generally the same. SSL and/or TLS provides endpoint authentication and privacy over a network using cryptography.

PEAP provides additional security for other EAP authentication protocols such as PEAP-MSCHAPv2. MSCHAPv2 refers to Microsoft Challenge Handshake Protocol, version 2. MSCHAPv2 is an authentication method in which a representation of the user's password is sent during the authentication process and a challenge is provided by a server to the client.

PEAP-GTC refers to PEAP Generic Token Card (GTC) and is an alternative to PEAP-MSCHAPv2. PEAP-GTC carries a text challenge from the authentication server and a reply which is assumed to be generated by a security token.

NTLMv1 refers to Network LAN (local area network) Manager, version 1. LDAP refers to Lightweight Directory Access Protocol. NTLMv1 and LDAP are alternative ways of communicating between a switch and an authenticating server. In the case of NTLMv1, the server may be an active directory (AD server).

In current network configurations, multiple Access Points (APs) are coupled to a wired network, such as an Ethernet network for example, and each AP operates as a relay station by supporting communications between resources of the wired network and wireless stations (STAs).

Some network systems include multiple groups of clients (for example, LANs) separated by substantial distances. A main authentication server (such as a RADIUS server) performs client authentication. There are at least two problems with having a RADIUS server perform client authentication. First, many modifications to the system require modifications to the RADIUS server. This can be time consuming and complicated. The logistical problems may be increased when the switch and server are physically separated by a substantial distance such as through the Internet or other long distance link.

A second problem with having a RADIUS server perform client authentication occurs when the RADIUS server and the switch are separated through a link distance link such as the Internet. If the link between groups of clients is down, the individual clients will not be authenticated. To solve this problem, a local redundant client authentication server performs client identification for a particular group of servers. The addition of these redundant authentication servers adds considerable expense and complexity.

### BRIEF DESCRIPTION OF THE DRAWINGS

The invention may best be understood by referring to the following description and accompanying drawings that are used to illustrate embodiments of the invention.

FIG. 1 is a block diagram representation of exemplary embodiments for a system including clients, an access point, a switch and a server computer, that performs local client authentication in accordance with a second authentication scheme.

FIG. 2 is an exemplary flowchart of the operations for performing translations between MSCHAPv2 and NTLMv1 protocols to support client authentication without need for a RADIUS server.

FIG. 3 is a block diagram representation of exemplary embodiments of a switch of FIGS. 1, 4, and 5.

FIG. 4 is a block diagram representation of a second exemplary embodiment for a system performing local client authentication in accordance with a second authentication scheme.

FIG. 5 is a flowchart providing a simplified representation of methods performed in system configurations utilizing a LDAP server as shown in FIGS. 4 and 6.

FIG. 6 is a block diagram representation of exemplary embodiments for a system similar to FIG. 4 that performs local client authentication in accordance with a third authentication scheme.

### DETAILED DESCRIPTION

Embodiments of the invention relate to the field of communication security, and in particular, to a system, apparatus, and method for providing local client authentication, such as wireless authentication. Local authentication means local with respect to a switch for the client as opposed to, for example, in a backend server.

A. First Authentication Scheme

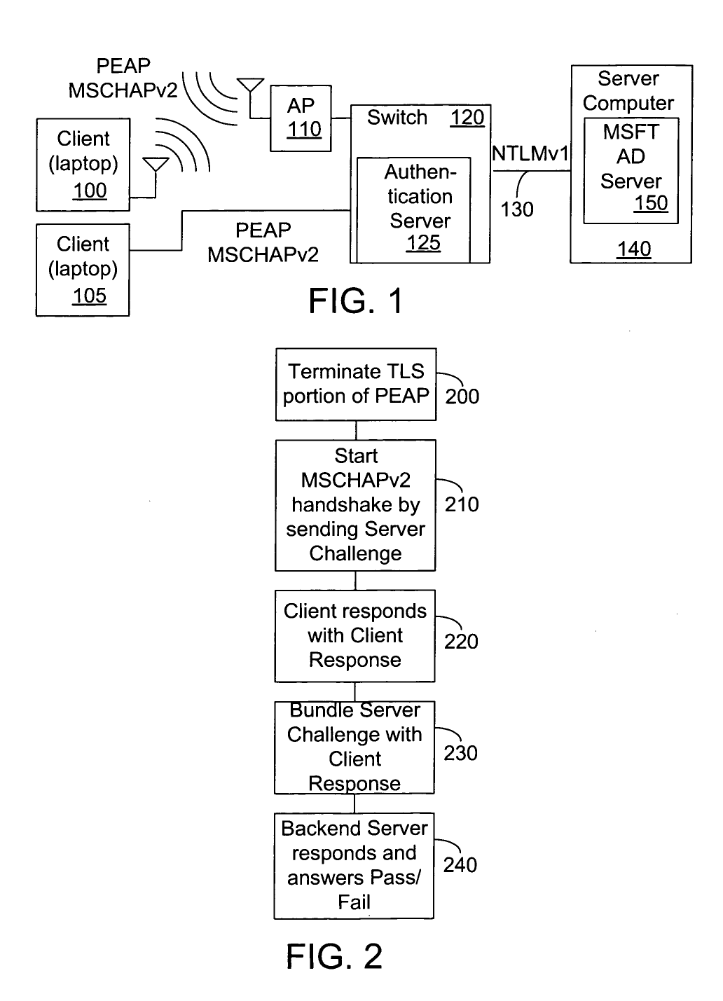

Referring to FIG. 1, an exemplary embodiment of a system performing local client authentication without the need of a RADIUS server is shown. Herein, a client 100 wirelessly communicates with an access point 110. At least some signals between client 100 and access point 110 follow a PEAP MSCHAPv2 authentication protocol. Access point 110 is coupled to switch 120, which is adapted to operate, at least in part, as an authentication server 125. A client 105 communicates with switch 120 through a wired link. At least some signals between client 105 and switch 120 follow the PEAP MSCHAPv2 authentication protocol.

Authentication server 125 terminates the PEAP MSCHAPv2 signals and performs client authentication as, for example, is described below. Clients 100 and 105 are examples of clients to be authenticated. Signals following the protocols described herein are in the form of packets although the principles could apply to other signaling formats. There may be additional devices on the network (for example, printers and other laptop or desktop computers), and it is not required that both clients 100 and 105 be on the network.

Switch 120 is also coupled through a link 130 to a backend server computer 140. A “link” is generally defined as any communication medium that enables information to be transferred to/from a destination device. Examples of link 130 include any wired communication medium (e.g., wire, cable, fiber optic, etc.), or any wireless communication medium such as radio frequency, light pulses, magnetic-based transmissions, and the like. At least some signals between switch 120 and server computer 140 follow an NTLMv1 authentication protocol. As an illustrative example, server computer 140 includes a MICROSOFT® Active Directory (MSFT AD) server 150 that receives signals under the NTLMv1 authentication protocol. Note that server computer 140 is a physical computer and MSFT AD server 150 is a software construct that is executed on server computer 140. MSFT AD server 150 terminates signals following the NTLMv1 authentication protocol and performs authentication under the NTLMv1 authentication protocol.

The following discussion provides examples of how authentication server 125 provides client authentication and bridges the PEAP-MSCHAPv2 to NTLMv1 authentication. Authentication server 125 handles PEAP-MSCHAPv2 authentication without the need of a backend RADIUS server such as in server computer 140. In some embodiments, the AD (active directory) of MSFT AD server 150 does not have to be configured for authentication of new clients.

The MSCHAPv2 authentication protocol is an authentication method that uses the NT PasswordHash (described below) as a basic component of the authentication process (see Request for Comment 2759). In general, the NT PasswordHash is placed in a message in accordance with the NTLMv1 authentication protocol, which is an authentication protocol that is substantially different from that of MSCHAPv2, but is adapted in the present invention to use NT PasswordHash for client authentication. Hence, the two seemingly unrelated algorithms can be used in conjunction to authenticate a client using PEAP-MSCHAPv2 while server 150 uses the NTLMv1 authentication protocol. This may be an attractive combination because PEAP-MSCHAPv2 is the default client authentication standard with the Windows XP operating system whereas NTLMv1 is also standard and enabled by default on a Win2K3 (2003) server without configuration. Further details are described in connection with the following processes in connection with blocks 200-240 in an exemplary flowchart illustrated in FIG. 2.

With respect to FIG. 2, an authentication server 125 of FIG. 1 terminates the TLS portion of PEAP (see block 200 of FIG. 2). Authentication server 150 of FIG. 1 starts the MSCHAPv2 handshake by sending a client, such as client 100 or client 105, a Server Challenge 260 (see block 210 of FIG. 2). According to one embodiment of the invention, the server challenge is 8-byte message. The Server Challenge, in combination with additional information, such as the user name and a user input password for example (not shown), undergoes a hash operation to produce the NT PasswordHash. According to one embodiment of the invention, the hash operation is in accordance with the Message Digest 4 (MD4) hash function.

Although not shown, it is contemplated that the NT PasswordHash is padded with additional information (e.g., “0” values) and separated into three (3) 7-byte value. These values are used to perform cryptographic operations (e.g., DES operations) on the Server Challenge in order to produce resultant 8-bytes values. These values are appended together to produce a Client Response. Of course, it is contemplated that the Client Response may be produced by other techniques, provided such techniques can be replicated at backend server 150.

According to this embodiment of the invention, Client Response is a 24-byte value, and is transferred from client 100 or 105 to authentication server 125 in accordance with the MSCHAPv2 authentication protocol (see block 220 of FIG. 2). Thereafter, authentication server 125 bundles the Server Challenge and the Client Response in accordance with the NTLMv1 authentication protocol for transmission to MSFT AD server 150 of FIG. 1 (see block 230 of FIG. 2). Since MSFT AD server 150 has access to the NT PasswordHash (stored when a user account is created and continues to update the hash whenever the user password changes) and receives the Server Challenge, it can compute a value for comparison with the Client Response supplied by authentication server 125. If a match is determined between the computed value and the received Client Response, MSFT AD server 150 provides a response (Pass) signal to authentication server 125 that the client has been authenticated (see block 240 of FIG. 2). Otherwise, MSFT AD server 150 provides a response (Fail) signal to authentication server 125 to deny client access to the network.

As can be seen from the message exchange described above, client authentication is performed by authentication server 125, but a portion of the complete authentication process is performed in MSFT AD server 150.

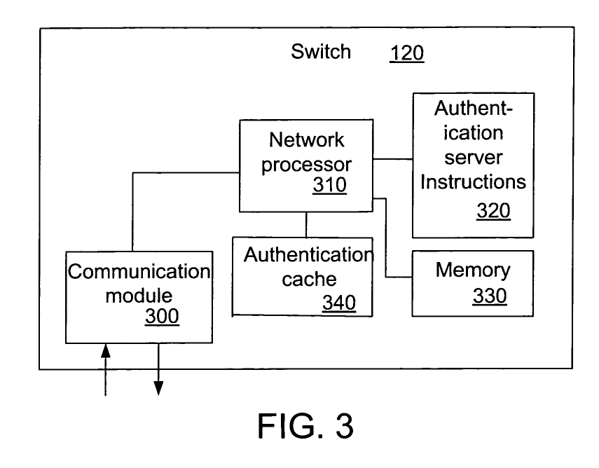

FIG. 3 illustrates an exemplary embodiment of switch 120, although other embodiments could be implemented. Referring to FIG. 3, switch 120 comprises a communications module 300 and a network processor 310 adapted to execute authentication server instructions 320. Herein, communications module 300 communicates with components outside switch 120 and components that enable switch 120 to operate as authentication server 125. Although separate unidirectional incoming and outgoing arrows are shown, communications could be bi-directional. Communications module 300 may communicate with other components of switch 120.

As further illustrated, network processor 310 is adapted to execute authentication server instructions 320 which may be stored in a memory such as internal memory 330. Instructions 320 may be stored in software or firmware, or hardwired.

Still referring to FIG. 3, an authentication cache 340 keeps track of which clients have been authenticated and receives credentials from server 150. In some embodiments, cache 340 is part of memory 330. With the credentials stored in cache 340, after then initial authentication, authentication server 125 can continue to authenticate clients even if link 130 is down. The credentials can be cached on a permanent basis or a temporary basis (e.g., for a predetermined time such as a few hours or a few days, until altered by the client, for a communication session, etc.). In some embodiments, the predetermined time is configurable.

Having server 125 of FIG. 1 perform the client authentication has two advantages. First, some modifications can be made to the network system without reconfiguring backend MSFT AD server 150. A second advantage occurs when a portion of link 130 goes down. For example, assume link 130 includes the Internet. If switch 120 temporarily loses access the Internet, clients 100 and 105 can continue to use other clients (such as a printer) that are part of the local network that includes switch 120.

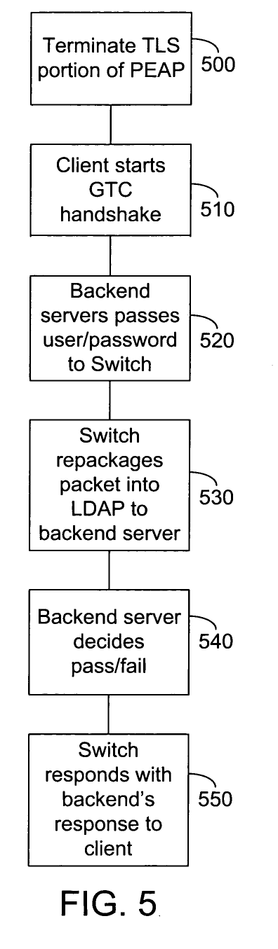

Credentials for these clients are cached in cache 340. In prior art systems, when the link between the backend server and the switch goes down, the clients of the switch are no longer authenticated and hence cannot use the local network. Alternatively, conventional systems use a local redundant client authentication server while still keeping the remote RADIUS server. By contrast, in the network system of FIG. 1, a backend RADIUS server is not needed for client authentication. More information regarding an example of responding to a link going down is provided in connected with FIG. 5.

B. Second Authentication Scheme

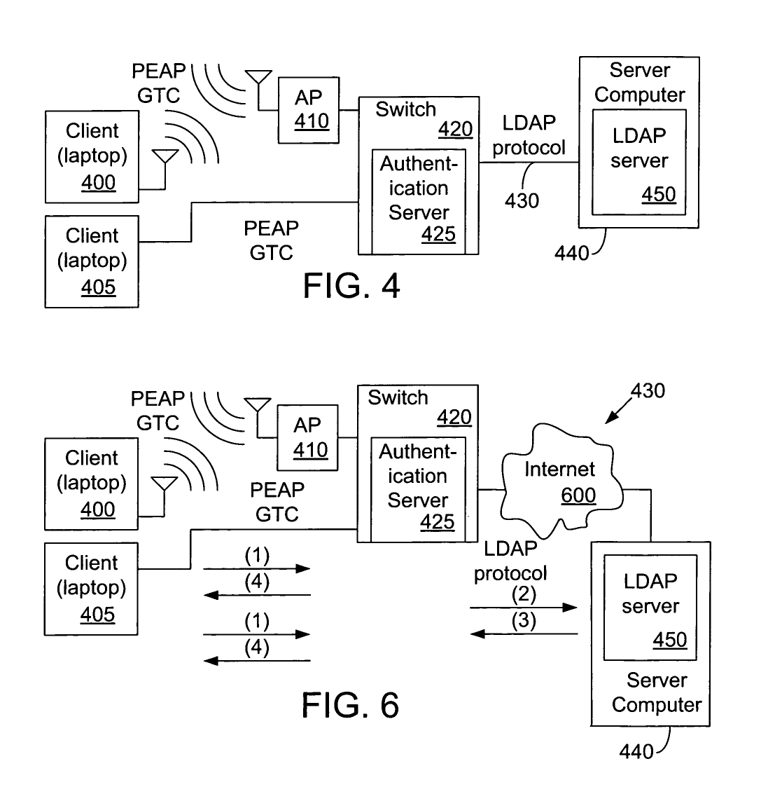

Referring to FIG. 4, a client 400 wirelessly communicates with an access point 410. At least some signals between client 400 and access point 410 follow a PEAP GTC authentication protocol. Access point 410 is coupled to switch 420, which includes logic that operate, at least in part, as an authentication server 425. A client 405 communicates with switch 420 through a wired link. At least some signals between client 405 and switch 420 follow the PEAP GTC authentication protocol. There may be additional devices on the network (for example, printers and other laptop or desktop computers) and it is not required that both clients 400 and 405 be on the network.

Switch 420 is also coupled through a link 430 to a backend server computer 440. At least some signals between switch 420 and server computer 440 follow a LDAP authentication protocol. Server computer 440 operates as a LDAP server 450 that terminates signals under the LDAP authentication protocol. LDAP server 450 performs authentication for the LDAP authentication protocol.

The following discussion provides examples of how authentication server 425 provides client authentication and bridges the PEAP GTC to LDAP authentication. Authentication server 425 handles PEAP GTC authentication without the need of a backend RADIUS Server such as in server computer 440. In some embodiments, LDAP server 450 does not have to be configured for authentication of new clients.

Not needing a RADIUS backend server is attractive because many different backend servers do not include RADIUS servers. The GTC authentication allows for the passing of the user/password pair to the backend LDAP server 450. Further details are described in connection with the following operations and in connection with blocks 500-550 in the flowchart of FIG. 5.

(1) Authentication server 425 terminates the TLS portion of PEAP (see block 500 of FIG. 5).

(2) Client 400 or 405 starts the GTC handshake (see block 510 of FIG. 5).

(3) Client 400 or 405 server 450 passes a user password for the GTC handshake to authentication server 520 (see block 520 of FIG. 5). The user password is encrypted within the TLS channel.

(4) Authentication server 425 receives the user password and repackages these packets in accordance with the LDAP protocol for transmission to LDAP server 450 (see block 530 of FIG. 5).

(5) LDAP server 450 determines whether the client passes or fails (see block 540 of FIG. 5).

(6) Switch 420 (authentication server 425) responds to LDAP server 450 decision regarding pass/fail by authenticating or not authenticating the client (see block 550 of FIG. 5).

The above described process is different than the prior art systems in that the prior art system handle PEAP GTC to RADIUS and then to LDAP. The above described process skips the RADIUS translation operations completely.

Although this embodiment describes an authentication scheme using LDPA server 450, it is contemplated that other types of servers may utilize this inventive authentication scheme, namely any type of server that processes a user name and password (or token). Examples include, but are not limited or restricted to NTLMv2 based sever, Kerberos-based server, RSA SecurID® server, RADIUS® and the like.

C. Third Authentication Scheme

FIG. 6 illustrates a network system that is similar to that of FIG. 4 except that link 74 includes the Internet 600. Details of operation are the same as in connection with FIG. 4, except when a connection established over a link 430 between switch 420 and server computer 440 is lost. In this situation, switch 420 is unable to communicate with server computer 440 after a client has been authenticated. Prior to any loss of connection, when the backend server computer 440 responds with a pass signal, switch 420 caches the user/password combination in cache (e.g., internal cache 340 of FIG. 3) either indefinitely or for a temporary period of time (which may be configurable). If backend server computer 440 becomes unreachable, switch 420 can authenticate a client (such as client 400) by using the cached user/password. The local clients (such as clients 400 and 405) can use local resources such as other clients of switch 420.

In FIG. 6, arrows (1), (2), (3), and (4) illustrate operation of the network system. When link 430 is operational, initial authentication involves path (1) between a client (such as client 400 or 405) and switch 420. Paths (2) and (3) are from switch 420 to server computer 440 and back to switch 420 with credentials to be cached in authentication cache 340 in switch 420. Switch 420 completes the authentication in path (4). Thereafter, when link 430 is down, paths (1) and (4) can continue without paths (2) and (3).

The above described system in connection with FIG. 6 is unique in that although other systems may have used credential caching, this is the first system to do so for PEAP-GTC (IEEE 802.x) without the use of a backend RADIUS server.

Wireless communications described herein may be in accordance with a wireless communication standard such as High Performance Radio LAN (HiperLan) or IEEE 802.11. Examples of different types of IEEE 802.11 standards include, but are not limited or restricted to (i) an IEEE 802.11b standard entitled “Wireless LAN Medium Access Control (MAC) and Physical Layer (PHY) specifications: Higher-Speed Physical Layer Extension in the 2.4 GHz Band” (IEEE 802.11b, 1999), (ii) an IEEE 802.11a standard entitled “Wireless LAN Medium Access Control (MAC) and Physical Layer (PHY) specifications: High-Speed Physical Layer in the 5 GHz Band” (IEEE 802.11a, 1999), (iii) a revised IEEE 802.11 standard “Wireless LAN Medium Access Control (MAC) and Physical Layer (PHY) specifications” (IEEE 802.11, 2003), or the like.

In some embodiments, instructions to perform the functions described herein are hardwired into the circuits. In other embodiments, at least some of the functions may be initiated through firmware and/software. Such firmware or software can be provided to the switch and access point over the Internet or through a storage medium such as a CD ROM, DVD, flash memory, or other memory.

While the invention has been described in terms of several embodiments, the invention should not limited to only those embodiments described, but can be practiced with modification and alteration within the spirit and scope of the appended claims. The description is thus to be regarded as illustrative instead of limiting.

1. An apparatus comprising:
a switch to interface between clients, the switch including an authentication server to perform client authentication for at least one of the clients.

2. The apparatus of claim 1, wherein the authentication server receives signals following a PEAP MSCHAPv2 protocol and interfaces with a backend server with signals following an NTLMv1 protocol.

3. The apparatus of claim 1, wherein the authentication server starts a handshake according to a first protocol by sending the client a server challenge, and receives the client's response.

4. The apparatus of claim 3, wherein the authentication server bundles a server challenge with the client's response and passes them according to a second protocol to be received by a backend server, and the authentication server receives a pass or fail answer from the backend server.

5. The apparatus of claim 4, wherein the first protocol is a PEAP MSCHAPv2 protocol and the second protocol is an NTLMv1 protocol.

6. The apparatus of claim 1, wherein the authentication server receives signals following a PEAP GTC protocol and interfaces with a backend server with signals following an LDAP protocol.

7. The apparatus of claim 1, wherein the authentication server receives a handshake from the client according to a first protocol and receives user/password signals for the handshake, and repackages signals following a second protocol to be provided to a backend server.

8. The apparatus of claim 7, wherein the authentication server receives a pass or fail response from the backend server and responds by authenticating or not authenticating the client accordingly.

9. The apparatus of claim 8, wherein the first protocol is a PEAP GTC protocol and the second protocol is an LDAP protocol.

10. The apparatus of claim 1, further comprising an access point and the client authentication includes client authentication for a client wirelessly coupled to the access point.

11. The apparatus of claim 10, further comprising a package to hold the switch and the access point.

12. The apparatus of claim 1, wherein the authentication server includes a network processor to execute authentication server instructions.

13. The apparatus of claim 1, wherein the authentication server includes an authentication cache to hold credentials of clients provided by a backend authentication server.

14. A system comprising:
an access point; and
a switch to interface between clients; and
a first authentication server to perform client authentication including for a wireless client by receiving signals following a first authentication protocol between at least one of the clients and the switch, and to interface with a backend server including a second authentication server with signals following with a second authentication protocol.

15. The system of claim 14, wherein the first authentication server is included in the switch.

16. The system of claim 14, further comprising the backend server and wherein the backend server does not include a RADIUS server.

17. The system of claim 14, wherein the first protocol is a PEAP MSCHAPv2 protocol and the second protocol is an NTLMv1 protocol.

18. The system of claim 14, wherein the first protocol is PEAP GTC protocol and the second protocol is an LDAP protocol.

19. The system of claim 14, wherein the first authentication server includes a network processor to execute authentication server instructions.

20. The system of claim 14, wherein the first authentication server includes an authentication cache to hold credentials of clients provided by the backend authentication server to be used by the first authentication server when a link between the first authentication server and the backend server is not operating.

21. A method comprising:
receiving signals following a first protocol from a client to a first authentication server that is used to authenticate the client;
performing a handshake between the client and the first authentication server;
providing results of the handshake to a second authentication server in a backend server with signals following a second protocol;
receiving a pass or fail signal from the backend server indicating whether the client is to be authenticated; and
authenticating or not authenticating the client according to the pass or fail signal.

22. The method of claim 21, wherein the first protocol is a PEAP MSCHAPv2 protocol and the second protocol is an NTLMv1 protocol.

23. The method of claim 21, wherein the first protocol is PEAP GTC protocol and the second protocol is an LDAP protocol.

24. The method of claim 21, further comprising holding credentials of clients provided by the backend authentication server to be used by the first authentication server when a link between the first authentication server and the backend server is not operating.

25. The method of claim 24, wherein the credentials are also used by the first authentication server when the link is operating.

26. The method of claim 21, wherein the client is wirelessly coupled to an access point that is coupled by wires to a switch that includes the first authentication server.
